(19) United States
(12) Patent Application Publication
(10) Pub. No.: US 2011/0068756 A1
(43) Pub. Date: Mar. 24, 2011

(54) BAND-GAP REFERENCE VOLTAGE GENERATION CIRCUIT

(76) Inventor: Seung-Hun Hong, Namyangju-si (KR)

(21) Appl. No.: 12/635,584

(22) Filed: Dec. 10, 2009

(30) Foreign Application Priority Data
Dec. 26, 2008 (KR) 10-2008-0134206

(51) Int. Cl. G05F 1/10

(52) U.S. Cl. 323/268

(57) ABSTRACT

A band-gap reference voltage generation circuit and methods thereof. A band-gap reference voltage generation circuit may include a current generator configured to generate a first current and/or a second current. A band-gap reference voltage generation circuit may include a current controller including a first resistor, through which a first current may flow, a first bipolar transistor connected with a first resistor at an emitter of a first bipolar transistor and/or connected with a node at a base of a first bipolar transistor, and/or a second bipolar transistor connected with a node at a base of a second bipolar transistor. A band-gap reference voltage generation circuit may include a current controller to generate a proportional to absolute temperature current, a feedback unit to control first and second currents to be substantially equal, and a band-gap voltage output unit to generate a reference voltage in response to a PTAT current.

The present application claims priority under 35 U.S.C. 119 to Korean Patent Application No. 10-2008-0134206 (filed on Dec. 26, 2008) which is hereby incorporated by reference in its entirety.

### BACKGROUND

Embodiments relate to a semiconductor device. Some embodiments relate to a band-gap reference voltage generation circuit which may substantially compensate for process variation, and methods thereof.

In a semiconductor memory device, currents output from transistors may be varied in accordance with a variation in temperature. The performance of a circuit constituted by transistors may be varied. For example, an increase in temperature may occur such that transistors may exhibit a relative decrease in mobility upon relatively strong inversion thereof. Currents output from transistors may be minimized, and/or operating speed of a circuit may be minimized.

To offset a performance variation of a semiconductor device which may be caused by a variation in temperature, a technique to vary a reference voltage in accordance with a variation in temperature may be used. In such a technique, a reference voltage may be relatively increased at a relatively high temperature, which may relatively increase current, whereas a reference voltage may be relatively decreased at a relatively low temperature, which may relatively reduce current. Thus, current output from each transistor may be maintained in a desired amount, irrespective of a variation in temperature, and/or it may be possible to secure a desired performance of a semiconductor device irrespective of a variation in temperature.

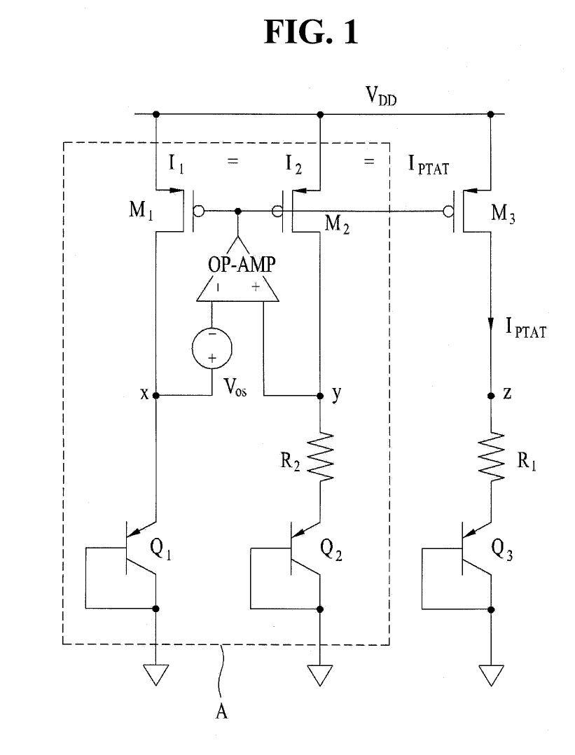

A band-gap reference voltage generation circuit may be used in a method of varying a reference voltage in accordance with a variation in temperature. Referring to example FIG. 1, a circuit diagram illustrates a band-gap reference voltage generation circuit. Reference voltage V_{ref} may be provided as a reference voltage for a circuit to generate an internal supply voltage. Current I_{PTAT} may be generated in a circuit indicated by a dotted-line box. Generated current I_{PTAT} may be mirrored into transistor M3, and/or may be supplied to a resistor R1. A positive temperature coefficient (TC) voltage may be generated. At node Z, a positive TC voltage, which may be generated by current I_{PTAT}, may be added to a base-emitter voltage of transistor Q3, namely, a negative TC voltage. Therefore, a band-gap reference voltage may be generated.

In a band-gap reference voltage generation circuit, there may be an offset of an input of an operational amplifier (OP-AMP) due to a process variation occurring in a manufacture of a chip. An offset voltage generated may be Vₒₛ, such that a resultant band-gap reference voltage may have an error corresponding to approximately 20×Vₒₛ. Accordingly, there is a need for a band-gap reference voltage generation circuit, and methods thereof, which may be capable of being substantially stable irrespective of process variation.

### SUMMARY

Embodiments relate to a band-gap reference voltage generation circuit and methods thereof. According to embodiments, a band-gap reference voltage generation circuit may substantially compensate for process variation.

According to embodiments, a band-gap reference voltage generation circuit may include a current generator generating a first current and/or a second current. In embodiments, a band-gap reference voltage generation circuit may include a current controller including a first resistor, through which a first current may flow. In embodiments, a band-gap reference voltage generation circuit may include a first bipolar transistor connected with a first resistor at an emitter of a first bipolar transistor, and/or connected with a node at a base of a first bipolar transistor. In embodiments, a band-gap reference voltage generation circuit may include a second bipolar transistor connected with a node at a base of a second bipolar transistor.

According to embodiments, a band-gap reference voltage generation circuit may include a current controller configured to generate a proportional to absolute temperature (PTAT) current at a first resistor. In embodiments, a band-gap reference voltage generation circuit may include a feedback unit configured to control first and/or second currents to be substantially equal. In embodiments, a band-gap reference voltage generation circuit may include a band-gap voltage output unit configured to generate a reference voltage in response to a PTAT current.

According to embodiments, a band-gap reference voltage generation circuit may include first and second bipolar transistors connected with each other between bases of first and second bipolar transistors. In embodiments, a band-gap reference voltage generation circuit may include a first bipolar transistor having an emitter area n times as large as an emitter area of a second bipolar transistor. In embodiments, a band-gap reference voltage generation circuit may include a first resistor, through which a first current may flow, and/or a first resistor connected with an emitter of a first bipolar transistor. In embodiments, a band-gap reference voltage generation circuit may include a feedback unit connected with a second bipolar transistor, which may be configured to control a second current flowing through a collector of a second bipolar transistor, such that a second current may be substantially equal to a first current.

### DRAWINGS

Example FIG. 1 is a circuit diagram illustrating a band-gap reference voltage generation circuit.

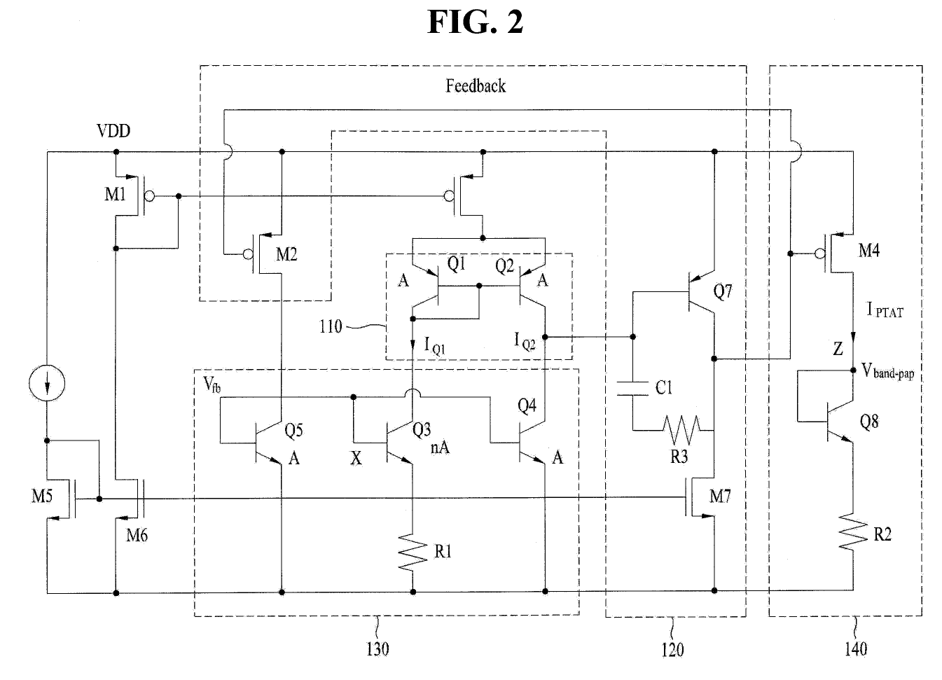

Example FIG. 2 is a circuit diagram illustrating a band-gap reference voltage generation circuit in accordance with embodiments.

### DESCRIPTION

Embodiments relate to a band-gap reference voltage generation circuit and methods thereof. Referring to example FIG. 2, a circuit diagram illustrates a band-gap reference voltage generation circuit in accordance with embodiments. According to embodiments, a band-gap reference voltage generation circuit may include current generator 110, feedback unit 120, current controller 130 and/or band-gap voltage output unit 140. In embodiments, current generator 110 may include PMOS transistor M3, bipolar transistor Q1 and/or bipolar transistor Q2. In embodiments, PMOS transistor M3 may receive, at a source thereof, a supply voltage VDD. In embodiments, PMOS transistor M3 may be connected, at a drain thereof, to emitters of bipolar transistor Q1 and/or bipolar transistor Q2. In embodiments, bases of bipolar transistor Q1 and bipolar transistor Q2 may be connected with each other. In embodiments, a base and a collector of a bipolar transistor Q1 may be connected with each other.

According to embodiments, current generator 110 may generate first current I_{Q1} and/or second current I_{Q2}. In embodiments, first current I_{Q1} may include a proportional to absolute temperature (PTAT) current, which may flow through first resistor R1. In embodiments, first current I_{Q1} may flow through a collector of bipolar transistor Q1, and/or second current I_{Q2} may flow through a collector of bipolar transistor Q2.

According to embodiments, feedback unit 120 may include capacitor C1, bipolar transistor Q7 and/or PMOS transistor M2. In embodiments, feedback unit 120 may control voltage V_{fb}, which may substantially equalize first current I_{Q1} and second current I_{Q2}. In embodiments, feedback unit 120 may substantially equalize first current I_{Q1} and second current I_{Q2} using a negative feedback. In embodiments, feedback unit 120 may include PMOS transistor M2 having a gate voltage varying in accordance with second current I_{Q2}.

According to embodiments, current controller 130 may include bipolar transistors Q3, Q4 and/or Q5. In embodiments, first resistor R1 may be included in current controller 130. In embodiments, a base and a collector of bipolar transistor Q3 may be connected with a drain of PMOS transistor Q2. In embodiments, bases of bipolar transistor Q3 and bipolar transistor Q4 may be connected with a drain of PMOS transistor M2. In embodiments, bases of bipolar transistor Q3 and bipolar transistor Q4 may be connected with the same node, such that substantially the same current may be applied to the bases. In embodiments, first resistor R1 may be connected with an emitter of bipolar transistor Q3. In embodiments, base voltages of bipolar transistor Q3 and bipolar transistor Q4 may be substantially equal. In embodiments, current I_{PTAT} output from current controller 130 may correspond to V_{BE2}−V_{BE1}/R1, and/or may be substantially equal to first and/or second currents I_{Q1} and/or I_{Q2}, for example I_{Q1}=I_{Q2}=I_{PTAT}=(V_{BE2}−V_{BE1})/R1.

According to embodiments, band-gap reference voltage output unit 140 may output band-gap reference voltage V_{band-gap} by mirroring first current I_{Q1} generated as described, namely, a PTAT current. In embodiments, generated PTAT current I_{PTAT} may be mirrored through PMOS transistors M2 and/or M4, and/or may be applied to second resistor R2. In embodiments, a positive temperature coefficient (TC) voltage may be generated. In embodiments, at a node Z, a positive TC voltage, which may be generated by current I_{PTAT}, may be added to a base-emitter voltage of a transistor Q4, namely, a negative TC voltage. In embodiments, band-gap reference voltage V_{band-gap} may be generated. In embodiments, an offset may not be generated when a PTAT current may be generated, since bases of bipolar transistors Q3 and Q4 may be connected with the same node, and/or since a condition of V_{BE2}=I_{PTAT}/R1=V_{BE1} may be established.

According to embodiments, band-gap reference voltage V_{band-gap} generated from a band-gap reference voltage generation circuit may be expressed as follows:

Embodiments including substantially no mismatch:

I_{Q1}=nIₛe^{V}^{_{BE1}}^{/V}^{_{T}}

I_{Q2}=nIₛe^{V}^{_{BE2}}^{/V}^{_{T}}

I_{Q1}I_{Q2}

∴V_{BE2}−V_{BE2}=V_{T}*In(n)

V_{X}=V_{Y}

∴V_{BE2}=I_{Q1}*R1+V_{BE1}

I_{Q1}=I_{PTAT}=V_{T}*In(n)/R1

∴V_{Z}=V_{BE4}+(R2/R1)*V_{T}*In(n)

Embodiments including mismatch, assuming I_{mismatch} and α may be generated due to a mismatch:

I_{Q1}′=I_{Q1}+I_{mismatch}=(n+α)Iₛe^{V}^{_{BE1}}^{/V}^{_{T}}

I_{Q1}′=I_{Q1}+I_{mismatch}=(n+α)Iₛe^{V}^{_{BE1}}^{/V}^{_{T}}

I_{Q2}′=I_{Q2}−I_{mismatch}=Iₛe^{V}^{_{BE2}}^{/V}^{_{T}}

I_{Q1}′=(1.02)*I_{Q2}′ (For example, I_{mismatch}=0.01*I_{Q1})

∴V_{BE2}−V_{BE2}=V_{T}*[In(n+α)−In(1.02)]

V_{X}=V_{Y}

∴V_{BE2}=I_{Q1}*R1+V_{BE1}

I_{Q1}=I_{PTAT}=[V_{T}*In(n+α)−In(1.02)]/R1

∴V_{Z}=V_{BE4}+(R2/R1)*V_{T}*[In(n+α)+(R2/R1)*V_{T}*In(1.02)

According to embodiments, a mismatch may occur due to process variation. In embodiments, first and second currents may be different from each other, for example I_{Q1}≠I_{Q2}, and/or a size (nA) of an emitter of bipolar transistor Q3 may not be substantially equal to n times the size (A) of an emitter of bipolar transistor Q4. In embodiments, such errors caused by mismatch may be as low as approximately 1/10 or less of the errors generated in other structures. In embodiments, a band-gap reference voltage generation circuit in accordance with embodiments may substantially prevent generation of an offset, for example using a feedback circuit. In embodiments, it may be possible to minimize voltage dispersion which may be caused by process variation.

It will be obvious and apparent to those skilled in the art that various modifications and variations can be made in the embodiments disclosed. Thus, it is intended that the disclosed embodiments cover the obvious and apparent modifications and variations, provided that they are within the scope of the appended claims and their equivalents.

What is claimed is:

1. An apparatus comprising:
a current generator configured to generate a first current and a second current;
a current controller comprising a first resistor through which said first current flows, a first bipolar transistor connected with said first resistor at an emitter of said first bipolar transistor and connected with a node at a base of said first bipolar transistor, and a second bipolar transistor connected with the node at a base of said second bipolar transistor, wherein said current controller is configured to generate a proportional to absolute temperature current at said first resistor;
a feedback unit configured to control said first current and said second current to be substantially equal; and
a band-gap voltage output unit configured to generate a reference voltage in response to said proportional to absolute temperature current.

2. The apparatus of claim 1, wherein said first current corresponds to said proportional to absolute temperature current.

3. The apparatus of claim 1, wherein said band-gap voltage output unit generates a substantially constant reference voltage irrespective of a process variation.

4. The apparatus of claim 1, wherein the emitter of said first transistor comprises an area at least approximately n times larger than an emitter area of said second transistor.

5. The apparatus of claim 1, wherein said feedback unit comprises a negative feedback.

7. The apparatus of claim 1, comprising a band-gap reference voltage generation circuit.

8. The apparatus of claim 1, wherein said current generator comprises:
a PMOS transistor, a first bipolar transistor and a second bipolar transistor of said current generator, wherein said PMOS transistor is configured to receive a supply voltage VDD at a source thereof and a drain thereof is connected with emitters of said first bipolar transistor and said second bipolar transistor of said current generator.

9. The apparatus of claim 8, wherein at least one of:
bases of said first bipolar transistor and said second bipolar transistor of said current generator are connected with each other; and
a base and a collector of said first bipolar transistor of said current generator are connected with each other.

10. The apparatus of claim 1, wherein said feedback unit comprises a capacitor, a bipolar transistor and a PMOS transistor.

11. The apparatus of claim 1, wherein said a band-gap voltage output comprises a bipolar transistor, a PMOS transistor and a resistor.

12. An apparatus comprising:
a first bipolar transistor and a second bipolar transistor connected with each other by bases of said first bipolar transistor and second bipolar transistor, wherein said first bipolar transistor comprises an emitter area n times as large as an emitter area of said second bipolar transistor;
a first resistor through which a first current flows, wherein said first resistor is connected with an emitter of said first bipolar transistor; and
a feedback unit connected with said second bipolar transistor configured to control a second current flowing through a collector of said second bipolar transistor such that said second current is substantially equal to said first current.

13. The apparatus of claim 12, wherein said feedback unit comprises a negative feedback.

14. The apparatus of claim 12, wherein said feedback unit is provided with a reference voltage output unit configured to generate a substantially constant reference voltage corresponding to said first current irrespective of a process variation.

15. The apparatus of claim 12, comprising a band-gap reference voltage generation circuit.

16. A method comprising:
providing a current generator generating a first current and a second current;
providing a current controller comprising a first resistor through which said first current flows, a first bipolar transistor connected with said first resistor at an emitter of said first bipolar transistor and connected with a node at a base of said first bipolar transistor, and a second bipolar transistor connected with the node at a base of said second bipolar transistor, wherein said current controller generates a proportional to absolute temperature current at said first resistor;
providing a feedback unit controlling said first current and said second current to be substantially equal; and
providing a band-gap voltage output unit generating a reference voltage in response to said proportional to absolute temperature current.

17. The method of claim 16, wherein said first current corresponds to said proportional to absolute temperature current.

18. The method of claim 16, wherein said band-gap voltage output unit generates a substantially constant reference voltage irrespective of a process variation.

19. The method of claim 16, wherein the emitter of said first transistor comprises an area at least approximately n times larger than an emitter area of said second transistor.

20. The method of claim 16, wherein said feedback unit comprises a negative feedback.
